(19) United States
(12) Patent Application Publication
(10) Pub. No.: US 2006/0129973 A1
(43) Pub. Date: Jun. 15, 2006

(54) Method and system for digital publication of electronic information

(76) Inventors: David C. Newcorn, Chicago, IL (US); James S. Chrzan, Chicago, IL (US)

Correspondence Address: Lesavich High-Tech Law Group, P.C., Suite 325, 39 S. LaSalle Street, Chicago, IL, 60603, US

(21) Appl. No.: 11/000,580

(22) Filed: Nov. 30, 2004

(51) Int. Cl. G06F 9/44

(52) U.S. Cl. 717/106

(57) ABSTRACT

A method and system for digital publication of electronic information. A digital publication is provided including plural page templates with instructions to generate and display a micro-article, one or more electronic advertisements and a persistent navigation bar. Plural pages are dynamically generated and displayed from the plural page templates to fit a display screen with no zooming or scrolling required regardless of a type of display screen used. The method and system also allow the digital publication to include one or more electronic links with a unique identifier for a known subscriber with contact information recorded in a first database (e.g., for a print publication) to identify the known subscriber to record use of the information from digital publication.

### COPYRIGHT NOTICE

Pursuant to 37 C.F.R. 1.71 (e), applicants note that a portion of this disclosure contains material that is subject to and for which is claimed copyright protection, such as, but not limited to, digital photographs, screen shots, user interfaces, or any other aspects of this submission for which copyright protection is or may be available in any jurisdiction. The copyright owner has no objection to the facsimile reproduction by anyone of the patent document or patent disclosure, as it appears in the U.S. Patent Office patent file or records. All other rights are reserved, and all other reproduction, distribution, creation of derivative works based on the contents of the application or any part thereof are prohibited by applicable copyright law.

### FIELD OF THE INVENTION

This invention is related to digital publications. More specifically, it relates to a method and system for digital publication of electronic information.

### BACKGROUND OF THE INVENTION

There are many types of print publications that are routinely converted into electronic format and provided as digital publications on computer networks like the Internet, intranets, etc. However, there are many problems associated with such digital publications. One problem is that the electronic format typically includes an image file such as a bit-mapped (BMP) file that is large and because of its size very slow to transmit and view over the computer network. Even if the image file is provide in a compressed format such as Joint Picture Expert Group (JPEG) format, it still may be relatively slow to transmit and view over the computer network causing user frustration.

There have also been attempts to convert portions of a print publication into electronic format using Portable Delivery Format (PDF). Such attempts include navigation and linking to various locations within the PDF document. However, most of these attempts including directly scanning in a paper copy of a print publication into a PDF document.

Another problem is that many print publications are scanned directly into some digital format directly as they appear in the print format. The print layout is typically not an appropriate layout for viewing on a computer network. For example, a user may be reading an article and the article may conclude on a later page. The user would then have to wait for download of several additional pages to finish the article. Individual pages may include advertisements that distract the user. The advertisements are typically not linked to the advertisers and thus do not take full advantage of advertising revenues.

Another problem is that publishers of printed periodicals, especially controlled circulation publications that make up the bulk of business-to-business publications, spend millions of dollars each year keeping their subscriber databases up to date. Those databases, as a result, have tremendous value.

However, there has always been a wall separating the subscriber database from these publications' web-sites and there is no linking between such databases. As a result, publishers are forced to report merely impressions and clicks to web-site advertisers, which is not nearly as valuable as indicating who has visited the site.

To solve this problem, some publishers require registration to access some or all of their web-sites to obtain the identity of their site visitors. But few have successfully linked such registration databases back to their subscriber database. At best, such publishers maintain a separate database which may contain some degree of unknown duplication with their subscriber databases.

Another problem is that it is not easy to track users who view advertisements and follow up articles and associated them with contact information. For example, a known user may have their contact information in a database associated with a specific offline print publication and then view a digital publication from the same or different publisher. There is typically no easy way to associate the known user for the print publication to a known user viewing the digital publication.

There have attempts to solve some of the problems with digital publications. For example, U.S. Published patent application No. 20040002896, published by Alanen et al. entitled “Collection of behavior data on a broadcast data network,” teaches “a method, system, and computer program product for collecting usage data to assist an advertiser with a targeted marketing activity wherein the advertiser accesses the usage data to determine an appropriate advertisement for a second user. The method comprises receiving a data resource from a communications network, storing the data resource, displaying the data resource for a first user, extracting usage data that relates a characteristic of the first user to a characteristic of the data resource, and storing the usage data. The method may further comprise requesting the data resource.”

U.S. Published patent application No. 20030156108, published by Vetro entitled “Consistent digital item adaptation,” teaches “a method and system adapts a digital item by parsing the digital item into a resource and a description of the resource. The resource is then adapted according to a digital item adaptation description to produce an adapted resource. The descriptor is then modified according to the digital item adaptation description to produce a modified descriptor consistent with the adapted resource. The modified descriptor and the adapted resource are combined to form a modified digital item.”

U.S. Published patent application No. 20020107727, published by Traub entitled “Method of recording and reporting consumer interaction with a digital publication,” teaches “a method of recording and reporting consumer interaction with a digital publication. The method of recording and reporting consumer interaction with a digital publication comprises the steps of advertisers submitting content to a surveyor, the surveyor incorporating the content submitted into a digital publication stored on a digital medium, sending the digital publication to consumers, consumers browsing the digital publication on consumer computers connected to a surveyor server via an internet, and consumer interaction histories being reported to the advertisers. The surveyor may send reports to the advertisers, either upon request by the advertisers or periodically as ordered by the advertisers. Each report may include a report identification section, a timeframe & quantity section, a map section, a response rates section, a usage rates section, and a spreadsheet button. Major advantages of the instant method of recording and reporting consumer interaction with a digital publication include real-time transparent reporting of consumer interactions and purchases, detailed interactions reporting including length of time spent in each digital publication section, and customizable reports to meet the needs of specific advertisers.”

U.S. patent application No. 20020129094, published by Reisman entitled “Software and method for automatically sending a data object that includes user demographics” teaches “a method for operating a user station that is configured for communications with a multiplicity of independently-operated data sources via a non-proprietary network includes steps for creating a send data object that includes user demographics, and automatically sending the send data object to a selected one of the data sources upon establishing the communication link, without any triggering user action. Corresponding software and user stations are also described.”

U.S. Published patent application No. 20010047373, published by Jones et al. entitled “Publication file conversion and display,” teaches “a computerized information display system extracts text data, lists of keywords, story rankings in order of story importance, and image maps identifying the location of stories from an input of publication files from a publisher. The system can generate a simultaneous display of a page image in which a story appears side-by-side with the text for the story when a particular story is selected, in order to allow a viewer can read the text while referring to the page image for visual cues about the text passage. The viewer can select a story from a displayed list of stories ranked in order of importance relative to other stories appearing on a page. The story rankings are derived based upon comparing one or more story importance indicators: location of the story on the page; size of type font of a headline associated with the story; size of type font associated with the story text; and size of text content for the story. The viewer can navigate to the text for a story on a displayed page by clicking in the story area on the page which is linked by image maps to the corresponding text passage. The viewer can also navigate to a text passage and page image by clicking on a keyword from a list of keywords extracted from the text input from the publisher. These computerized contextual display and image navigation tools allow the viewer a highly interactive experience with the publication. They allow a publication to be converted to electronically viewable form frequently, e.g., several times per day, and in a more user friendly form than the original printed copy.”

U.S. Pat. No. 5,819,032, that issued to de Vries, et al. entitled “Electronic magazine which is distributed electronically from a publisher to multiple subscribers” teaches “an electronic magazine is distributed electronically over a network (e.g., Internet) from a publisher to multiple subscribers. In an initial timeline navigation screen depicted on the subscriber's computer display, articles are graphically represented in a graphical user interface as article boxes overlaid on a background. A marker is added to the article boxes to indicate that comments to the underlying article have been published as part of the magazine. To view the various comments for a particular article, the subscriber activates the article box to launch a second screen which includes the selected article box positioned prominently, and one or more graphical comment boxes indicative of the commentaries surrounding the article box. This second screen thereby provides a message thread of articles and related commentaries. An alternative approach to building a message thread is to launch a pop-up graphical list window from activation of the selected article which lists related commentaries. To submit a commentary on an article, the subscriber locates a file containing a previously drafted comment and drags a file icon representing the comment file to a submission target on the magazine's graphical user interface. The subscriber drops the file icon on the submission target which causes the computer to automatically send the comment file, along with identification of the article to which the comment relates, over the network to the publisher. The publisher can then review the commentary and at their discretion, add the commentary to the magazine or discard it. A time line showing the temporal relationship of when articles and commentaries are published within a publishing period is also provided as part of the graphical user interface. As an indicator is moved along the time line, the graphical article boxes are added to or removed from the screen to demonstrate which articles were published at which times within the publishing period.”

In addition, Qiosk, Inc. provides a digital magazine produced via the QuVu technology. More information is available about QuVu technology Universal Resource Locator (URL) “www.quvu.com.” According to the QuVu web-site “QuVu is an innovative new digital delivery format that makes onscreen reading easier and more exciting. (For those who still prefer hard copy, the full magazine or selected pages and articles can be easily printed out.) Instead of trying to fit the print edition to a screen, QuVu is designed specifically for reading magazines and other publications on screen. QuVu enables the user to view the magazine without having to manipulate the pages, i.e., zoom-in, zoom-out; moving around the page, etc. This revolutionary format contains all of the original magazine's editorial content, but repurposes it for easier onscreen viewing, regardless of screen size, shape, platform or operating system. Advertising can be picked up exactly from traditional sources, or pre-formatted to screen dimensions. As QuVu incorporates full Adobe PDF functionality, it does not require a proprietary reader or downloading special software. With file sizes under 1-2 MB, QuVu can easily be delivered as an e-mail attachment.”

However, none of these attempts solve all of the problems described above for digital publications. Thus, it is desirable solve the described problems and other problems for more efficient publication of digital information.

### SUMMARY OF THE INVENTION

In accordance with preferred embodiments of the invention, some of the problems associated with digital publications are overcome. A method and system for digital publication of electronic information is presented.

The method and system include, but is not limited to, a method and system for digital publication of electronic information. A digital publication is provided including plural page templates with instructions to generate and display a micro-article, one or more electronic advertisements and a persistent navigation bar. Plural pages are dynamically generated and displayed from the plural page templates to fit a display screen with no zooming or scrolling required regardless of a type of display screen used. The method and system also allow the digital publication to include one or more electronic links with a unique identifier for a known subscriber with contact information recorded in a first database (e.g., for a print publication) to identify the known subscriber to record use of the information from digital publication.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary digital publishing system;

FIG. 2 is a flow diagram illustrating a method for providing a page of electronic content for a digital magazine;

FIG. 3 is a flow diagram illustrating a method for presenting a digital magazine;

FIG. 4 is a block diagram illustrating an exemplary displayed digital magazine page;

FIG. 5 is a flow diagram illustrating for method for automatically registering use of electronic information in a digital publication;

FIGS. 6A and 6B are a flow diagram illustrating a method for tracking use of a digital publication;

FIG. 7 is a block diagram illustrating an exemplary front of an electronic or paper “thank you” message;

FIG. 8 is a block diagram illustrating an exemplary back of an electronic or paper “thank you” message;

FIG. 9 is a block diagram illustrating an exemplary output report.

### DETAILED DESCRIPTION OF THE INVENTION

Exemplary Digital Publishing System

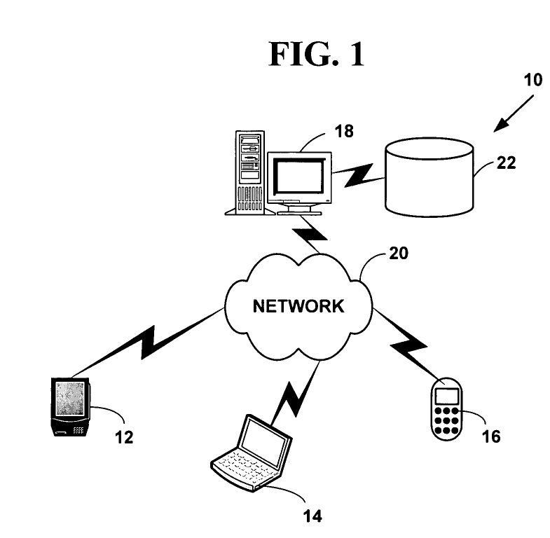

FIG. 1 is a block diagram illustrating an exemplary digital publishing system 10. The digital publishing system 10 includes, but is not limited to, plural network devices 12, 14, 16 (three of which are illustrated). The plural network devices 12, 14, 16 include but are not limited to desktop computers, laptop computers, personal digital/data assistants (PDAs), mobile phones, non-mobile phones, interactive TV systems through set top boxes for cable television (CATV), satellite television or other television networks, Internet appliances and other types of network devices.

The plural network devices 12, 14, 16 communicate with a one or more information servers 18 (one of which is illustrated) using one or more wired or wireless communications protocols over a communications network 20. The one or more information servers 18 include one or more servers hosting a web-site. The one or more information servers 18 may also include file servers or other types of servers.

The communications network 20 includes, but is not limited to, the Internet, an intranet, a wired Local Area Network (LAN), a wireless LAN (WiLAN), a Wide Area Network (WAN), a Metropolitan Area Network (MAN), Public Switched Telephone Network (PSTN) and other types of communications networks 18 providing voice, video and data communications.

The communications network 20 may include one or more gateways, routers, or bridges. As is known in the art, a gateway connects computer networks using different network protocols and/or operating at different transmission capacities. A router receives transmitted messages and forwards them to their correct destinations over the most efficient available route. A bridge is a device that connects networks using the same communications protocols so that information can be passed from one network device to another.

The communications network 20 may also include one or more additional servers or access points (AP) including wired and wireless access points (WAP) (not illustrated). The one or more servers include web-site servers, file servers and other types of servers.

The one or more information servers 18 include one or more associated databases 22 (one of which is illustrated). The one or more associated databases 22 include plural digital magazines in plural digital formats, including, but not limited to, Hyper Text Markup Language (HTML), Extensible Markup Language (XML), flash media, Java and various combinations thereof.

Preferred embodiments of the present invention include network devices that are compliant with all or part of standards proposed by the Institute of Electrical and Electronic Engineers (“IEEE”), International Telecommunications Union-Telecommunication Standardization Sector (“ITU”), European Telecommunications Standards Institute (ETSI), Internet Engineering Task Force (“IETF”), U.S. National Institute of Security Technology (“NIST”), American National Standard Institute (“ANSI”), Wireless Application Protocol (“WAP”) Forum, Data Over Cable Service Interface Specification (DOCSIS), Bluetooth Forum, or the ADSL Forum. However, network devices based on other standards could also be used. IEEE standards can be found on the World Wide Web at the Universal Resource Locator (“URL”) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” DOCSIS documents can be found at the URL “www.cablemodem.com.” Bluetooth Forum documents can be found at the URL “www.bluetooth.com.” WAP Forum documents can be found at the URL “www.wapforum.org.” ADSL Forum documents can be found at the URL “www.adsl.com.”

The plural network devices 12, 14, 16 include a protocol stack with multiple layers based on the Internet Protocol or Opens Systems Interconnection (OSI) reference model. The protocol stack includes, but is not limited to, Transmission Control Protocol (TCP), User Datagram Protocol (UDP), Internet Protocol (EP), Hypertext Transfer Protocol (HTTP) and other communication protocols.

As is known in the art, the OSI reference model is a layered architecture that standardizes levels of service and types of interaction for computers exchanging information through a communications network. The OSI reference model separates network device-to-network device communications into seven protocol layers, or levels, each building-and relying--upon the standards contained in the levels below it. The OSI reference model includes from lowest-to-highest, a physical, data-link, network, transport, session, presentation and application layer. The lowest of the seven layers deals solely with hardware links; the highest deals with software interactions at the application-program level.

TCP provides a connection-oriented, end-to-end reliable protocol designed to fit into a layered hierarchy of protocols that support multi-network applications. For more information on TCP 58 see RFC-793, incorporated herein by reference.

UDP provides a connectionless mode of communications with datagrams in an interconnected set of networks. For more information on UDP see ITEF RFC-768 incorporated herein by reference.

IP is an addressing protocol designed to route traffic within a network or between networks. For more information on IP 54 see IETF RFC-791 incorporated herein by reference.

HTTP is a standard protocol for communications on the World Wide Web. For more informaiton on HTTP, see IETF RFC-2616 incorporated herein by reference.

An operating environment for the devices used in the digital publishing system 10 include a processing system with one or more high speed Central Processing Unit(s) (“CPU”), one or more processors and one or more memories. In accordance with the practices of persons skilled in the art of computer programming, the present invention is described below with reference to acts and symbolic representations of operations or instructions that are performed by the processing system, unless indicated otherwise. Such acts and operations or instructions are referred to as being “computer-executed,” “CPU-executed,” or “processor-executed.”

It will be appreciated that acts and symbolically represented operations or instructions include the manipulation of electrical signals or biological signals by the CPU or processor. An electrical system or biological system represents data bits which cause a resulting transformation or reduction of the electrical signals or biological signals, and the maintenance of data bits at memory locations in a memory system to thereby reconfigure or otherwise alter the CPU's or processor's operation, as well as other processing of signals. The memory locations where data bits are maintained are physical locations that have particular electrical, magnetic, optical, or organic properties corresponding to the data bits.

The data bits may also be maintained on a computer readable medium including magnetic disks, optical disks, organic memory, and any other volatile (e.g., Random Access Memory (“RAM”)) or non-volatile (e.g., Read-Only Memory (“ROM”), flash memory, etc.) mass storage system readable by the CPU. The computer readable medium includes cooperating or interconnected computer readable medium, which exist exclusively on the processing system or can be distributed among multiple interconnected processing systems that may be local or remote to the processing system.

Exemplary Methods for Digital Publishing

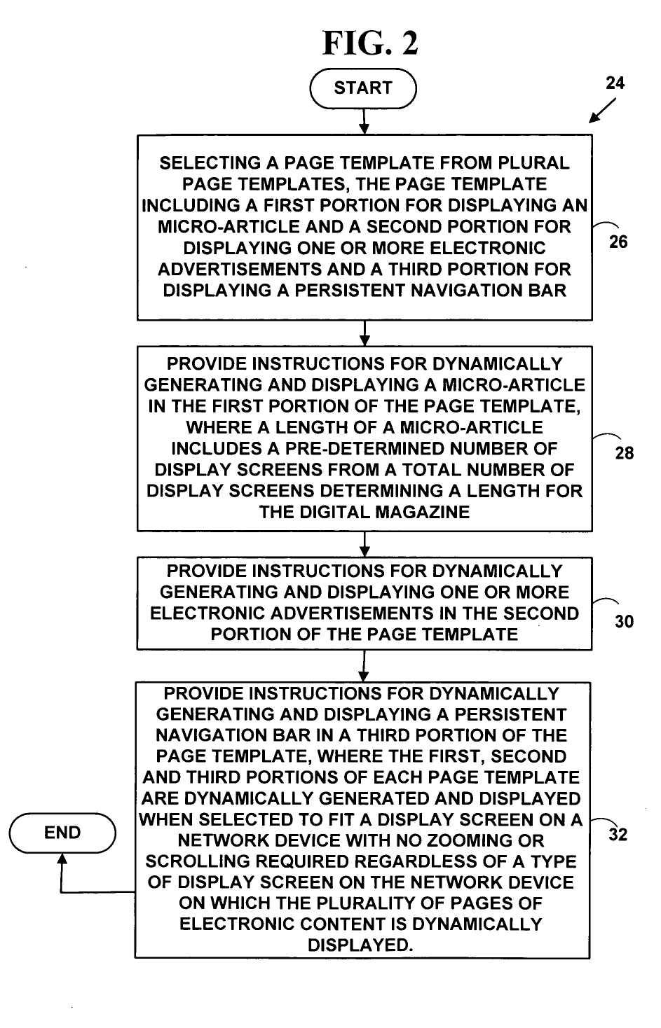

FIG. 2 is a flow diagram illustrating a Method 24 for providing a page of electronic content for a digital magazine. At Step 26, a page template is selected from available plural page templates. The page template includes a first portion for displaying a micro-article and a second portion for displaying one or more electronic advertisements and a third portion for displaying a persistent navigation bar. At Step 28, instructions are provided for dynamically generating and displaying a micro-article in the first portion of the page template. A length of a micro-article includes a pre-determined number of display screens from a total number of display screens determining a length for the digital magazine. At Step 30, instructions are provided for dynamically generating and displaying one or more electronic advertisements in the second portion of the page template. At Step 32, instructions are provided for dynamically generating and displaying a persistent navigation bar in a third portion of the page template. The first, second and third portions of each page template are dynamically generated and displayed when selected to fit a display screen on a network device with no zooming or scrolling required regardless of a type of display screen on the network device on which the plurality of pages of electronic content is dynamically displayed.

Method 24 is illustrated with an exemplary embodiment. However, the invention is not limited to this exemplary embodiment and other embodiments can also be used to practice the invention.

In one embodiment, at Step 26, a page template is selected from plural page templates stored in a database 22.

In such an exemplary embodiment, the page templates include flash media page templates. As is know in the art, flash media is a multimedia technology developed to allow a large of amount of user interactivity to fit in a relatively small file size. In another embodiment, the page templates include HTML page templates. However, the present invention is not limited to this embodiment and other types of page templates can also be used (e.g., XML, Java, Java Script, Visual Basic, etc.). In addition, other types of multi-media or static media technologies known in the art can also be used to practice the invention.

The flash page templates themselves are stored in very small file sizes, designed to transfer and load extremely quickly to give a very light and fast feel to a viewing experience of the digital magazine.

In such an exemplary embodiment the page templates allow electronic content including micro-articles and electronic advertisements to be laid out to fit a display screen of a network device 12, 14, 16 with no zooming, scrolling, downloading or special software required, regardless of a network device's operating system, screen resolution, or display software including browser software.

In such an exemplary embodiment, the micro-articles are extremely short and no bigger than about two display screens in length are obtained from authors and stored in database 22. Most articles are one display screen in length. The entire digital magazine is typically no bigger than about 25 or less display screens in length. This is a radical departure from current digital magazine efforts, most of which center around exactly replicating a print edition of the magazine. However, the article and digital magazine size are exemplary only and micro-article and digital magazines of other sizes can also be used to practice invention.

In such an exemplary embodiment, the one or more electronic advertisements include text-only advertising. The text-only advertising includes one or more electronic links to additional advertising content. The text-only advertising provides less distractions for viewers and allows the viewer to select advertising they are interested in and allow such selections to tracked as is explained below.

In such an exemplary embodiment, the one or more electronic advertisements include one or more electronic resources including other than micro-article format related to the micro-article displayed with the one or more electronic advertisements. Such electronic resources include, but are not limited to, electronic white papers, product descriptions, product instructions, research papers and other types of electronic resources.

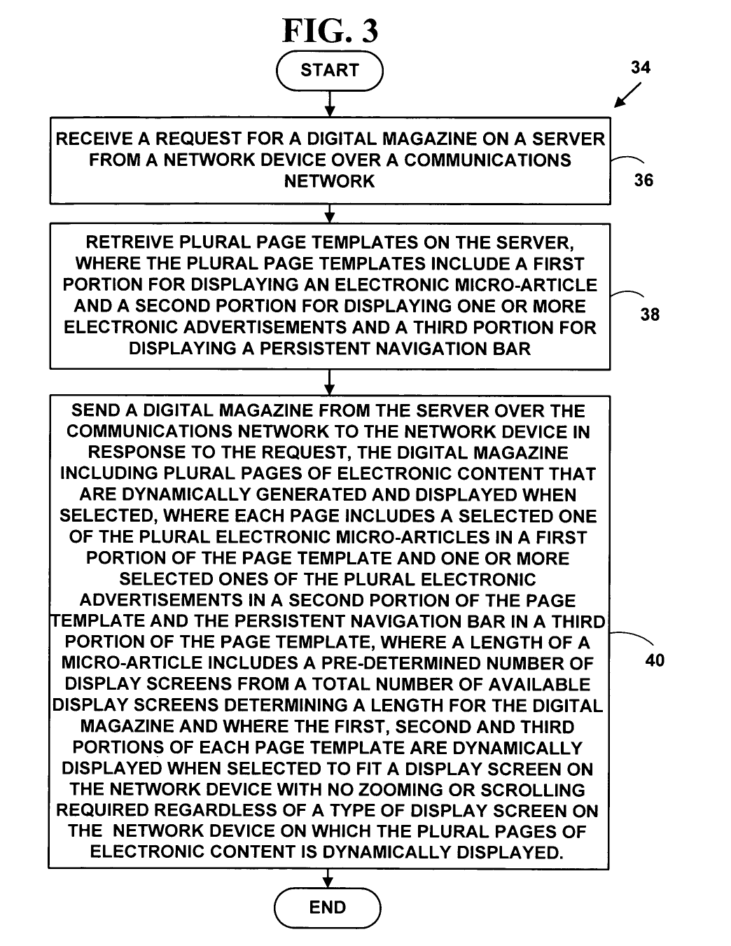

FIG. 3 is a Method 34 for presenting a digital magazine. At Step 36, a request for a digital magazine is received on a server 18 from a network device 12, 14, 16 over a communications network 20. At Step 38, plural page templates are retrieved on the server 18. The plural page templates include a first portion for displaying an micro-article and a second portion for displaying one or more electronic advertisements and a third portion for displaying a persistent navigation bar. At Step 40, a digital magazine is sent from the server 18 over the communications network 20 to the network device 12, 14, 16 in response to the request, the digital magazine including plural pages of electronic content that are dynamically generated and displayed on the network device 12, 14, 16. Each displayed page includes a selected one of the plural micro-articles in a first portion of the page template and one or more selected ones of the plural of electronic advertisements in a second portion of the page template and the persistent navigation bar in a third portion of the page template. A length of a micro-article includes a pre-determined number of display screens from a total number of available display screens determining a length for the digital magazine. The first, second and third portions of each page template are dynamically displayed to fit a display screen on the network device with no zooming or scrolling required regardless of a type of display screen on the network device on which the plurality of pages of electronic content is dynamically displayed.

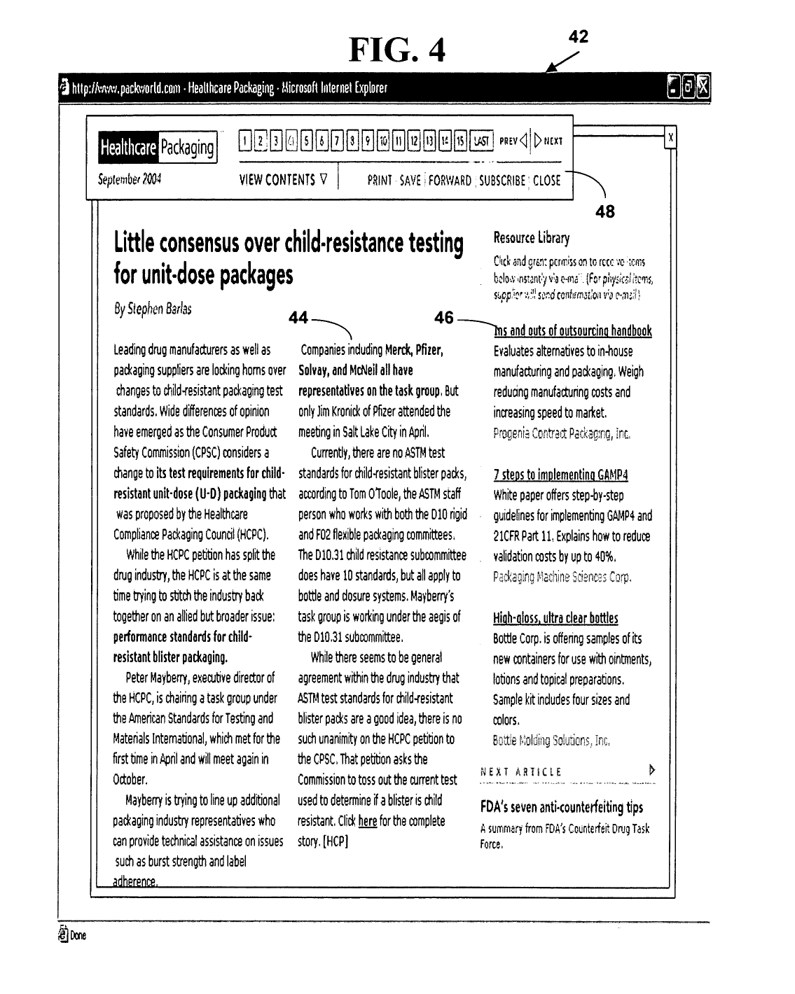

FIG. 4 is a block diagram illustrating an exemplary displayed digital magazine page 42. The exemplary displayed digital magazine page 42 includes a micro-article 44 in a first portion of the displayed page, plural electronic advertisements 46 in a second portion of the displayed page, and a persistent navigation bar 48 displayed in a third portion of the displayed page.

In one embodiment, the persistent navigation bar 48 is always present no matter what page a user is displaying. The persistent navigation bar includes but is not limited to a TITLE (e.g., Heathcare Packaging) and DATE (e.g., September 2004) of the digital magazine, a VIEW CONTENTS link, that is used to allow a viewer to view a table of contents of the entire digital magazine, PRINT, SAVE, FORWARD, SUBSCRIBE and CLOSE link. The persistent navigation bar also includes graphical boxes including a total number of pages in the digital magazine and a PREV(vios) and NEXT link.

The PRINT link prints a printer friendly copy of the display page. The SAVE link saves an electronic copy of the displayed page on the network device 12, 14, 16. The BOOKMARK link creates a link to the displayed page in a browser being used on the network device 12, 14, 16. The SUBSCRIBE link allows a viewer to subscribe to either the digital publication or additional offerings either by the author of the micro-article or one or more advertisers as is described below. The CLOSE link closes the displayed page. The PREV(vious) and NEXT link display previous and next pages respectively.

A viewer always knows where he/she has been by a highlighted page number (e.g., page 4). Once page has been viewed, the page number is “filled in” with a different color to indicate that the page has been viewed.

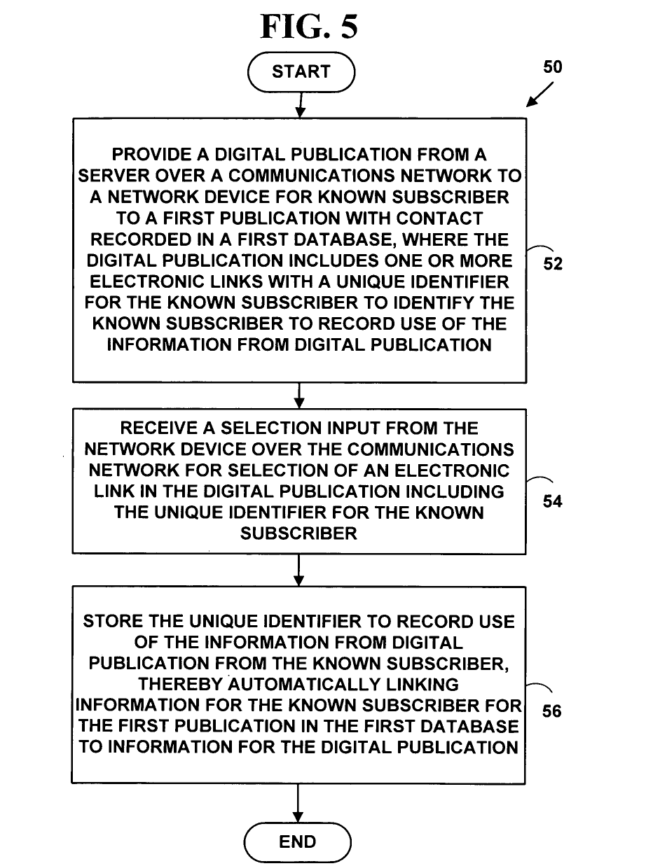

FIG. 5 is a flow diagram illustrating a Method 50 for automatically registering use of electronic information in a digital publication. At Step 52, a digital publication is provided from a server 18 over a communications network 20 to a network device 12, 14, 16 for known subscriber to a first publication. The digital publication includes one or more electronic links with a unique identifier for the known subscriber to identify the known subscriber to record use of the information from digital publication. At Step 54, a selection input is received from the network device 12, 14, 16 over the communications network 20 for selection of an electronic link in the digital publication including the unique identifier for the known subscriber. At 56, the unique identifier is stored to record use of the information from the digital publication, thereby automatically linking information for the known subscriber for the first publication in the first database to information from the digital publication.

Method 50 is illustrated with an exemplary embodiment details. However, the invention is not limited to this exemplary embodiment and other embodiments can also be used to practice the invention.

In one embodiment, the first publication is a print publication. In another embodiment, the first publication is other than a print publication (e.g., another digital publication).

Method 50 allows a user to register with a “1-click inquiry” using the one or more electronic links. The “1-click inquiry” allows the server 18 to recognize that particular known subscriber upon clicking any subsequent page in the digital publication, during that visit or any subsequent visit from the current digital publication, any new digital publications, other types of publication (e.g., print publications) or any other source which includes the unique identifier.

In such an exemplary embodiment At Step 52, one or more electronic links in the form of Universal Resource Locators (URLs) are added to a digital publication that is sent from a publisher of a digital publication to a known subscriber of a first publication. Each of the one or more electronic links a variable specific to each subscriber representing their unique identifier in a first subscriber database.

Table 1 illustrates an exemplary electronic link added to the digital publication. However, the present invention is not limited to such an electronic link and other types of electronic links can also be used to practice the invention.

TABLE 1

http://www.packworld.com/cds_search.html?rec_id=17851&UID=4120503

In Table 1, the electronic link is a URL that includes a digital publication identifier (e.g., 17851) and a unique subscriber identifier (e.g., 4120503).

At Step 54, when a user of the network device 12, 14, 16, selects an electronic link in the digital publication that unique identifier (3975601) is passed to the server 18 in the URL. The server 18, in turn, detects the presence of that unique identifier.

At Step 56, the server 18 records the unique identifier for the digital publication and relates and links the unique identifier back to the first database for the first publication.

In one embodiment, the server 18 records the unique identifier in a second database. The second database includes information collected for the digital publication.

In another embodiment, the server 18 sets a digital cookie on the network device 12, 14, 16 that allows the server 18 to recognize that particular known subscriber upon clicking any subsequent page in the digital publication, during that visit or any subsequent visit from the current digital publication, any new digital publications, other print publications or any other source which includes the unique identifier.

The server 18 has been programmed to look for the unique identifier in the URL any time it is supplied, if present, no matter what type of URL it is provided in or where it is provided from. For example, the unique identifier can be provided from other than the digital publication.

The server 18 has access to data associated with the known subscriber that was originally been collected online or offline (e.g., via paper or telephone, etc.), and which includes but is not limited to, mailing address, e-mail address, company size, industry, job title and any other demographic data found in the print publication database for that record. Thus, the user of the digital publication never has to fill out any additional electronic or paper registration forms to be recorded by the publisher of the digital publication.

In one embodiment, Method 50 further comprises sending the unique identifier for the known subscriber from the server 18 via the communications network 20 to one or more other servers providing other digital publications, wherein the unique identifier is used to identify a known subscriber from the other digital publications provided by the one or more other servers.

In one embodiment of the invention, the server 18 queries, in real-time, the first database containing subscriber data to the print publication. This lookup database can either exist on the publisher of the digital publication's server 18. The real-time query can also be done via the communications network 20 a server of a publisher of the publication or on a server of a circulation vendor that maintains the data on behalf of the publisher.

In another embodiment of the invention, the server 18 sets a digital cookie on the network device 12, 14, 16 comprising the unique identifier and other information that was passed in the URL and then relates the unique identifier to the subscriber data in the first database for the first publication at some later time, either daily, weekly or monthly, on a batch basis. This embodiment doesn't require an online connection over the communications network 20 to the first database for the first publication which may or may not be hosted and maintained by a third party circulation vendor.

In one embodiment, the digital publication provided at Step 52 is the digital magazine including the micro-articles, electronic advertisements and persistent navigation bar described above and illustrated in FIGS. 2-4.

In another embodiment, the digital publication provided at Step 52 can be replaced with an electronic mail (e-mail) message offering automatic registration to another digital publication using an electronic mail address recorded in the first database. In such an embodiment, a user would be registered using the e-mail and would not receive any digital publications including any electronic links with any additional unique identifiers that would be used to identify and register a user.

Using Method 50 the first time a user clicks any link in a provided digital publication, that user is permanently registered on the server 18. A user merely has to click once on an electronic link from a digital publication and it's the equivalent to filling out an electronic form and registering on the server 18 or filing out a paper form. The user can then be tracked upon visiting any subsequent link in any digital publication provided by the server 18 or from any other source that includes the unique identifier.

Method 50 also allows a known subscriber who has auto-registered on the server 18 to be recognized as a registered subscriber on another server for another digital publication provided by same publisher or a different publisher. As was described above, the server 18 sends the unique identifier to other servers for other digital publications.

For example, a known subscriber to print Magazine A receives an e-mail newsletter offering a subscription to Digital Magazine A and clicks on an electronic link. Using Method 50 the known subscriber is auto-registered on Magazine A's server 18. At some point, that known subscriber clicks on an electronic link for a digital publication provided by the same (or another) publisher providing a Digital Magazine B. The know subscriber is automatically recognized on server 18 or another server providing Digital Magazine B.

In another embodiment, a known subscriber is also auto-recognized using Method 50. Instead of one digital cookie being set on the network device 12, 14, 16 two cookies are set; one by the server the known subscriber is visiting, and another, third-party cookie that can be read by the third-party server via some software added to any digital publication in the publisher's network of servers.

Using Method 50, a server can recognize a return visitor by planting a digital cookie in on the visitor's network device 12, 14, 16 the first time that visitor registers with the server 18. Method 50 allows a server 18 to automatically register a known subscriber (without any user intervention) from data collected on that known subscriber from a source (e.g., the print subscription database) other than server 18 to which the known subscriber record is being linked.

Method 50 allows multiple databases to related to one another, including but not limited to: (1) print subscriber databases (auto-registered and traditionally registered); (2) content databases from a digital publication provided by server 18 including links to other pages on the same server 18 including the digital publication; (3) Links to external servers hosting web-site databases including both ads and editorial content; (4) advertiser and prospect databases; and (5) third-party vendor or provider databases.

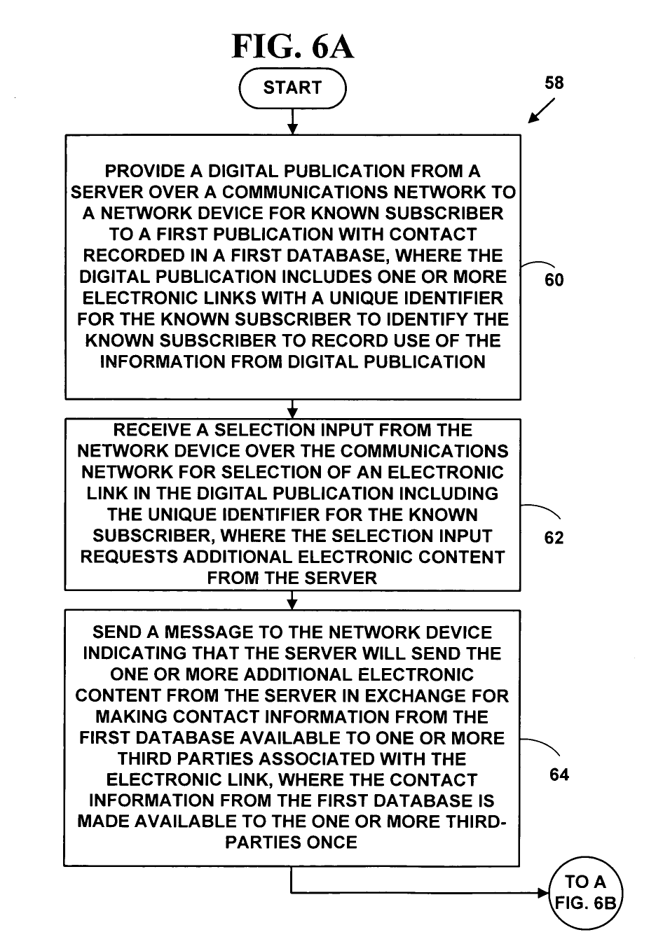

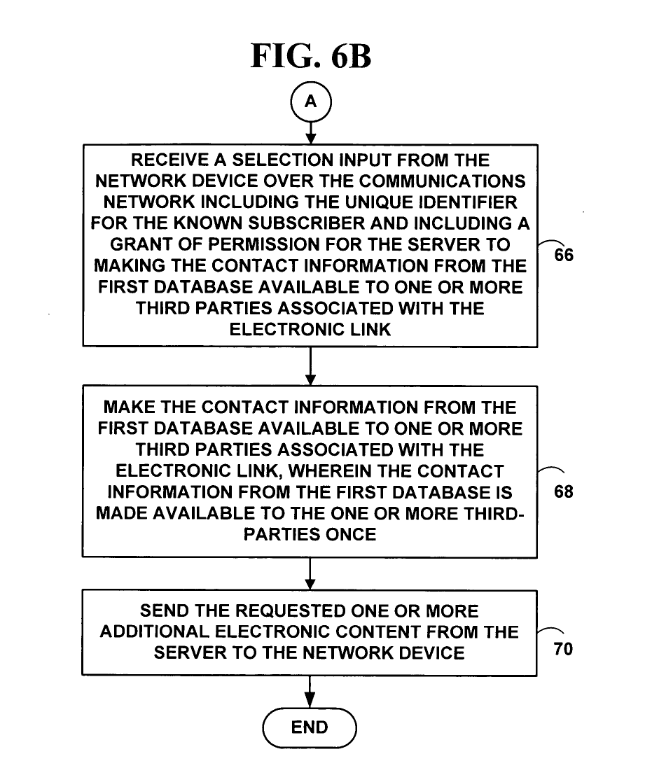

FIGS. 6A and 6B are a flow diagram illustrating a Method 58 for tracking use of a digital publication. In FIG. 6A at Step 60, a digital publication is provided from a server 18 over a communications network 20 to a network device 12, 14, 16 for a known subscriber to a first publication with contact information recorded in a first database. The digital publication includes plural pages with one or more electronic links with a unique identifier for the known subscriber to identify the known subscriber to record use of the information from digital publication. At Step 62, a selection input is received from the network device 12, 14, 16 over the communications network 20 for selection of an electronic link in the digital publication including the unique identifier for the known subscriber. The selection input requests additional electronic content from the server 18. At Step 64, a message is sent to the network device 12, 14, 16 indicating that the server 18 will send the additional electronic content from the server 18 in exchange for making contact information from the first database available to one or more third parties associated with the electronic link. The contact information from the first database is made available to the one or more third-parties only once.

In FIG. 6B at Step 66, a selection input is received from the network device 12, 14, 16 over the communications network 22 including the unique identifier for the known subscriber and including a grant of permission for the server 18 to make the contact information from the first database available to one or more third parties associated with the electronic link. At Step 68, the contact information from the first database is made available to one or more third parties associated with the electronic link. The contact information from the first database is made available to the one or more third-parties. At Step 70, the requested additional electronic content are sent from the server 18 to the network device 22.

Method 58 is illustrated with an exemplary embodiment. However, the invention is not limited to this exemplary embodiment and other embodiments can also be used to practice the invention.

In another embodiment at Steps 64 and 68 the contact information from the first database is made available to the one or more third-parties once is not recorded by the one or more third parties.

In one embodiment of the invention, at Step 60, the digital publication is provided page-by-page from the server 18 as the digital publication is viewed on a network device 12, 14, 16. The pages are dynamically generated and displayed using instructions from page templates as they are selected.

In another embodiment of the invention, at Step 60, a digital publication is provided including a combination of static pages previously created and retrieved from the server 18 and/or database 22 as they are selected and other pages provided on a page-by-page basis that are dynamically generated and displayed using instructions from page templates as they are selected.

In another embodiment of the invention, at Step 60, a digital publication is provided that includes only static pages previously created and retrieved from the server 18 and/or database 22 as they are selected.

The additional digital publications sent at Step 70 include similar combinations of dynamically generated and displayed pages as was just described for Step 60 above.

In one embodiment, the digital publication provided at Step 60 is the digital magazine including the micro-articles, electronic advertisements and persistent navigation bar described above and illustrated in FIGS. 2-4.

Using Method 58 and also using conventional registration such as filling out paper forms or registering by telephone, it is possible for publisher of a digital publication to know the identity of a subscriber for every page, micro-article or electronic advertisement clicked by that known subscriber. Advertisers are keen to know who is clicking on their ads and articles. Though a publisher of a digital magazine can report general information such as company name or job title, most reasonable people would agree that it may be a violation of that known subscriber's privacy to provide name, e-mail address, phone, and other contact information without the subscriber's permission when they click on a web-page or web-ad associated with a specific advertiser. Such privacy rights are also governed by privacy statements or subscription terms.

So under the tenets of permission marketing, the advertiser has to give something to get something. If the advertiser offers something of value including, but not limited to, a white paper, handbook, product sample, catalog, or other specific call to action, permission can be granted by the user on a one-time basis to give up their contact information in exchange for obtaining the item offered by the advertiser using Method 58.

The publisher or site operator makes it clear to the site user that by clicking a specially designated link (e.g., an advertising link) the known subscriber agrees to give up their contact info to the advertiser in exchange for the item being offered. This so-called “1-click inquiry” link allows the publisher or site operator to generate inquiries for advertisers without requiring subscribers to fill out a form each time they want the item featured in the call to action ad. This is a form of “click-wrap license” in which a temporary opt-in on a transaction basis, not a permanent one. A known subscriber's contact information will not be given up on any subsequent link they click they give permission again.

In one embodiment, when a known subscriber gives permission to release contact information a “thank you” message is sent to the network device 12, 14, 16, indicating the transaction has taken place. Since giving up contact information can be a little jarring to the user experience, an additional safeguard such as a “are you sure?” message that explicitly informs the known subscriber they are giving up their contact information in exchange for the item being requested may be sent. The thank you message can actually be an electronic form that gives them the option of receiving the requested item immediately via e-mail or via postal mail (including various types of express mail) and thus not giving up their email address, but still obtaining the desired item by giving up their physical address.

In one embodiment, for any user who clicks on a 1-click ad to receive additional electronic content from an advertiser, a customized, personalized 4-color thank you postcard is generated that contains logos, graphics and wording that is derived from one or more databases. This postcard can be completely personalized and customized on a one-of-a kind basis depending on any attribute of any database (e.g., the industry job duty of the person who clicked, the nature of the specific ad they clicked, etc.)

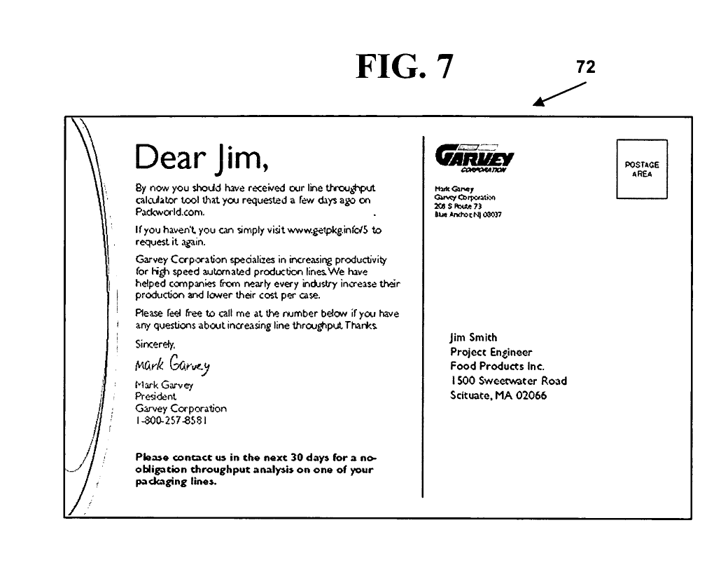

FIG. 7 is a block diagram 72 illustrating an exemplary front of an electronic or paper “thank you” message. In one embodiment, this thank you message comprises an electronic postcard automatically sent in an e-mail via the communications network 20 to the network device 12, 14, 16 upon receiving permission from the known subscriber to give permission to release contact information.

In another embodiment, this thank you message includes a paper post card automatically sent via post mail upon receiving permission from the known subscriber to give permission to release contact information.

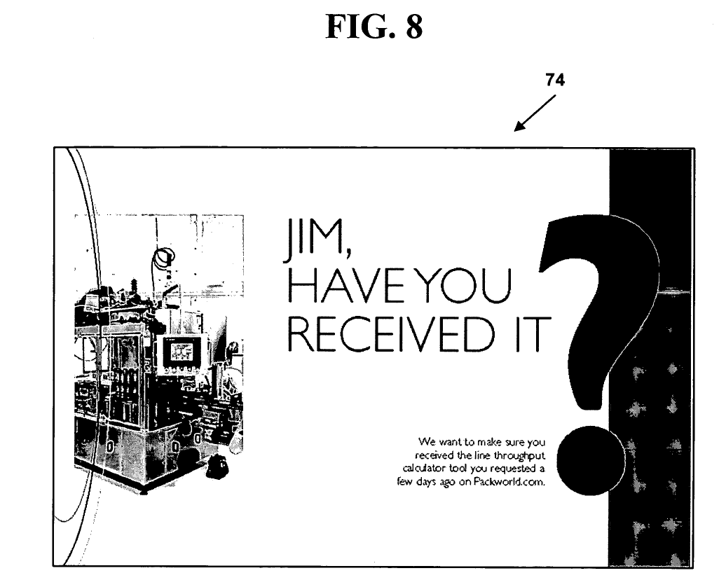

FIG. 8 is a block diagram 74 illustrating an exemplary back of an electronic or paper “thank you” message.;

In one embodiment, for advertising content a special variable is added to any existing advertising redirect URL which first logs the click through via a page on the publishers' site, before redirecting to the advertiser's site. The server's 18 or the web-site's software looks for the presence of that variable. If it exists, then that request is treated as an inquiry, and the user's full contact information is disseminated to the advertiser electronically.

In another embodiment, the advertising redirect URL itself refers to an ad database that simply contains a record with a field that indicates this is a 1-click inquiry, and rather than redirecting to the advertiser's Web-site, it goes onto an inquiry processing server.

In one embodiment, Method 58 further includes automatically preparing on the sever 18 one or more summary reports for the one or more third parties based on received selection inputs; and automatically sending the one or more summary reports from the server 18 to other servers for the one or more third parties via the communications network 20.

In another embodiment, Method 58 further includes manually preparing one or more summary reports for the one or more third parties based on received selection inputs; and manually sending the one or more summary reports to the one or more third parties via Postal Mail.

The one or more reports are produced with varying level of detail based on the wishes of the known subscribers. For example, for each advertiser and prospective advertiser a number of impressions and clicks not only on advertising, but also on editorials can be recorded. Further, for a given advertiser or prospective advertiser, actual data from the subscriber database (which may partially obscured to protect subscribers' privacy) for any known subscriber who clicked on any ad or article associated with the advertiser or prospective advertiser. Finally, for known subscribers who requested information from advertisers via a 1-click inquiry link and give explicit permission for contact information to be released, it is possible to disseminate the full contact information for that known subscriber.

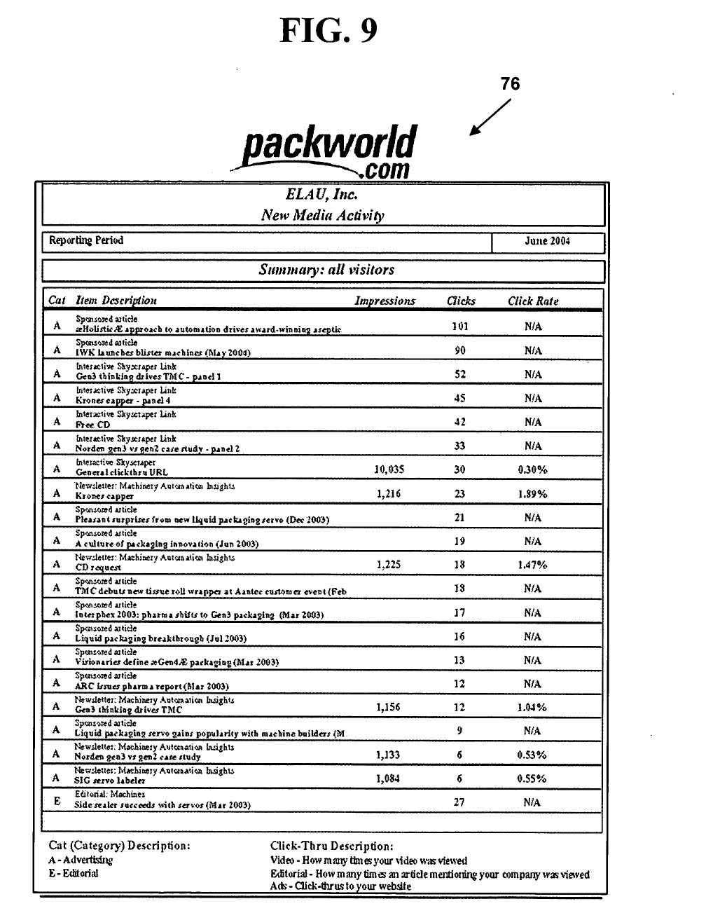

FIG. 9 is a block diagram 76 illustrating an exemplary output report. FIG. 9 illustrates an exemplary output report illustrating limited detail but including a number of clicks on advertising and editorials from a digital magazine.

The methods and systems described herein can also provide at least the following: (1) Target headlines in notification e-mail based on database attributes, where a digital publication (e.g., the digital magazine with micro-articles described above) is delivered via e-mail notification that includes a link to specific articles in the magazine. This includes a “database publishing” model where the headline links are customized individual subscribers based on their industry or other attributes in the individual database that houses their information; (2) Digital publication gallery where multiple pieces of electronic content on a page can be expanded upon in a special viewer window; and (3) A download center on server 18 where advertisers can log in to download full contact information of those who clicked their 1-click ads. Advertisers can log in to download full contact information of those who clicked their 1-click ads. Again, this is not unique by itself, but it's all part of this product.

The methods and systems described herein are not related or limited to any particular type of computer or network system (hardware or software), unless indicated otherwise. Various types of general purpose or specialized computer systems may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams.

While various elements of the preferred embodiments have been described as being implemented in software, in other embodiments hardware or firmware implementations may alternatively be used, and vice-versa.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. A method for providing a page of electronic content for a digital magazine, comprising:
selecting a page template from a plurality of available page templates, the page template including a first portion for displaying a micro-article and a second portion for displaying one or more electronic advertisements and a third portion for displaying a persistent navigation bar;
providing instructions for dynamically generating and displaying a micro-article in the first portion of the page template, wherein a length of a micro-article includes a pre-determined number of display screens from a total number of available display screens determining a length for the digital magazine;
providing instructions for dynamically generating and displaying one or more electronic advertisements in the second portion of the page template;
providing instructions for dynamically generating and displaying a persistent navigation bar in a third portion of the page template;
wherein the first, second and third portions of each page template are dynamically generated and displayed when selected to fit a display screen on a network device with no zooming or scrolling required regardless of a type of display screen on the network device on which the plurality of pages of electronic content is dynamically displayed.

2. The method of claim 1 further comprising a computer readable medium having stored therein instructions for causing one or more processors to execute the steps of the method.

3. The method of claim 1 wherein the plurality page of templates include a plurality of flash media page templates or a plurality of Hypertext Markup Language (HTML) templates

4. The method of claim 1 wherein a length for a micro-article includes at most two display screens.

5. The method of claim 1 wherein a length of the digital magazine includes 25 or less display screens.

6. The method of claim 1 wherein the one or more electronic advertisements include text-only advertising, wherein the text-only advertising includes one or more electronic links to additional advertising content.

7. The method of claim 1 wherein the one or more electronic advertisements include one or more electronic resources related to the micro-article displayed with the one or more electronic advertisements.

8. The method of claim 1 wherein the persistent navigation bar includes a TITLE and a DATE of the digital magazine, a VIEW CONTENTS link, that is used to allow a viewer to view a table of contents of the entire digital magazine, a PRINT, SAVE, SUBSCRIBE, BOOKMARK and CLOSE link, a plurality of graphical boxes including a total number of pages in the digital magazine and a PREVIOUS and NEXT link.

9. A method for presenting a digital magazine, comprising:
receiving a request for a digital magazine on a server from a network device over a communications network;
retrieving a plurality of page templates on the server, the plurality of page templates including a first portion for displaying a micro-article and a second portion for displaying one or more electronic advertisements and a third portion for displaying a persistent navigation bar; and
sending a digital magazine from the server over the communications network to the network device in response to the request, the digital magazine including a plurality of pages for which electronic content is dynamically generated and displayed,
wherein each page of the digital magazine includes a page template from plurality of page templates with a selected one of the plurality of micro-articles in a first portion of the page template and one or more selected ones of the plurality of electronic advertisements in a second portion of the page template and the persistent navigation bar in a third portion of the page template,
wherein a length of a micro-article includes a pre-determined number of display screens from a total number of available display screens determining a length for the digital magazine, and
wherein the first, second and third portions of each page template are dynamically generated and displayed when selected to fit a display screen on the network device with no zooming or scrolling required regardless of a type of display screen on the network device on which the plurality of pages of electronic content is dynamically displayed.

10. The method of claim 9 further comprising a computer readable medium having stored therein instructions for causing one or more processors to execute the steps of the method.

11. The method of claim 9 wherein the plurality of page templates include a plurality of flash media page templates or a plurality of Hypertext Markup Language (HTML) templates

12. The method of claim 9 wherein a length of a micro-article includes at most two display screens.

13. The method of claim 9 wherein a length of the digital magazine includes 25 or less display screens.

14. The method of claim 9 wherein the one or more electronic advertisements include text-only advertising, wherein the text-only advertising includes one or more electronic links to additional advertising content.

15. The method of claim 9 wherein the one or more electronic advertisements include one or more electronic resources related to the micro-article displayed with the one or more electronic advertisements.

16. The method of claim 9 wherein the persistent navigation bar includes a TITLE and a DATE of the digital magazine, a VIEW CONTENTS link, that is used to allow a viewer to view a table of contents of the entire digital magazine, a PRINT, SAVE, FORWARD, SUBSCRIBE, BOOKMARK and CLOSE link, a plurality of graphical boxes including a total number of pages in the digital magazine and a PREVIOUS and NEXT link.

17. A method for automatically registering use of a digital publication, comprising:
providing a digital publication from a server over a communications network to a network device for a known subscriber to a first publication with contact information recorded in a first database, wherein the digital publication includes one or more electronic links with a unique identifier for the known subscriber to identify the known subscriber to record use of the information from digital publication;
receiving a selection input from the network device over the communications network for selection of an electronic link in the digital publication including the unique identifier for the known subscriber; and
storing the unique identifier to record use of the information from digital publication from the known subscriber, thereby automatically linking information for the known subscriber for the first publication in the first database to information for the digital publication.

18. The method of claim 17 further comprising a computer readable medium having stored therein instructions for causing one or more processors to execute the steps of the method.

19. The method of claim 17 wherein the digital publication is a digital magazine comprising a plurality of pages for which electronic content is dynamically generated and displayed,
wherein each page of the digital magazine includes a page template with a micro-articles in a first portion of the page template, one or more electronic advertisements in a second portion of the page template and a persistent navigation bar in a third portion of the page template,
wherein a length of a micro-article includes a pre-determined number of display screens from a total number of available display screens determining a length for the digital magazine, and
wherein the first, second and third portions of each page template are dynamically generated and displayed when selected to fit a display screen on the network device with no zooming or scrolling required regardless of a type of display screen on the network device on which the plurality of pages of electronic content is dynamically displayed.

20. The method of claim 17 wherein the digital publication is an electronic mail message.

21. The method of claim 17 further comprising:
setting a digital cookie on the network device including the unique identifier that allows the server to recognize the known subscriber upon clicking any subsequent page in the digital publication, during a current visit or any subsequent visit from the current digital publication, a new digital publication or any other source which includes the unique identifier.

22. The method claim 17 further comprising:
receiving an additional selection input from another digital publication including the unique identifier provided by other than the server providing the digital publication; and
recognizing the known subscriber using the unique identifier.

23. The method of claim 17 further comprising:
sending the unique identifier for the known subscriber from the server via the communications network to one or more other servers providing other digital publications, wherein the unique identifier is used to identify a known subscriber from the other digital publications provided by the one or more other servers.

24. A method for tracking use of a digital publication, comprising:
providing a digital publication from a server over a communications network to a network device for a known subscriber to a first publication with contact information recorded in a first database, wherein the digital publication includes one or more electronic links with a unique identifier for the known subscriber to identify the known subscriber to record use of the information from digital publication;
receiving a selection input from the network device over the communications network for selection of an electronic link in the digital publication including the unique identifier for the known subscriber, wherein the selection input requests additional electronic content from the server; and
sending a message to the network device indicating that the server will send the additional electronic content from the server in exchange for making contact information from the first database available to one or more third parties associated with the electronic link, wherein the contact information from the first database is made available to the one or more third-parties once and is not recorded by the one or more third-parties.

25. The method of claim 24 further comprising a computer readable medium having stored therein instructions for causing one or more processors to execute the steps of the method.

26. The method of claim 24 wherein the digital publication is a digital magazine comprising a plurality of pages for which electronic content is dynamically generated and displayed,
wherein each page of the digital magazine includes a page template with a micro-articles in a first portion of the page template, one or more electronic advertisements in a second portion of the page template and a persistent navigation bar in a third portion of the page template,
wherein a length of a micro-article includes a pre-determined number of display screens from a total number of available display screens determining a length for the digital magazine, and
wherein the first, second and third portions of each page template are dynamically generated and displayed when selected to fit a display screen on the network device with no zooming or scrolling required regardless of a type of display screen on the network device on which the plurality of pages of electronic content is dynamically displayed.

27. The method of claim 24 further comprising:
receiving a selection input from the network device over the communications network including the unique identifier for the known subscriber and including a grant of permission for the server to making the contact information from the first database available to one or more third parties associated with the electronic link;
making the contact information from the first database available to one or more third parties associated with the electronic link, wherein the contact information from the first database is made available to the one or more third-parties once and is not recorded by the one or more third-parties; and
sending the requested additional electronic content from the server to the network device.

28. The method of claim 24 wherein the digital publication is an electronic mail message.

29. The method of claim 24 wherein the digital publication is an electronic advertisement.

30. The method of claim 24 wherein the additional electronic content include white papers, product descriptions, product instructions, product samples, catalogs or research papers.

31. The method of claim 24 further comprising:
automatically preparing on the sever one or more summary reports for the one or more third parties based on received selection inputs; and
automatically sending the one or more summary reports from the server to other servers for the one or more third parties via the communications network.

32. A digital publication system, comprising in combination:
a plurality of micro-articles, wherein a length of a micro-article includes a pre-determined number of display screens from a total number of available display screens determining a length for a digital publication;
a plurality of electronic advertisements;
a persistent navigation bar;
a plurality of page templates for a digital publication, including instructions for dynamically generating and displaying a micro-article in a first portion of the page template, instructions for dynamically generating and displaying one or more text electronic advertisements in a second portion of the page template, and instructions for dynamically generating and displaying a persistent navigation bar in a third portion of the page template,
wherein the first, second and third portions of each page template are dynamically generated and displayed when selected to fit a display screen on a network device with no zooming or scrolling required regardless of a type of display screen on the network device on which the plurality of pages of electronic content is dynamically displayed, and
wherein the digital publication is provided from a server over a communications network to the network device for a known subscriber to a first publication with contact information recorded in a first database, wherein the digital publication includes one or more electronic links with a unique identifier for the known subscriber to identify the known subscriber to record use of the information from digital publication.
